(19) United States
(12) Patent Application Publication
(10) Pub. No.: US 2002/0001517 A1
(43) Pub. Date: Jan. 3, 2002

(54) Arrangement at a lifting hook

(76) Inventor: Arne Aarre, Sandnes (NO)

Correspondence Address: DANIEL D. FETTERLEY, ANDRUS, SCEALES, STARKE & SAWALL, LLP, Suite 1100, 100 East Wisconsin Avenue, Milwaukee, WI, 53202-4178, US

(21) Appl. No.: 09/893,814

(22) Filed: Jun. 28, 2001

(30) Foreign Application Priority Data
Jun. 29, 2000 (NO) 20003417

(51) Int. Cl. B66C 1/00

(52) U.S. Cl. 414/729

(57) ABSTRACT

A device for coupling a load/lifting tool (3) to a crane (1) or other lifting equipment of the type used in heavy lift operations in which the load (4) must be controlled in such a manner that conventional hook, chain/wire tools can not be used, and where the device for coupling up the load/lifting tool (3) is constituted by a rapid coupling (2).

This invention regards a hook arrangement for connecting heavy packages to a hook or other lifting equipment.

When connecting up heavy packages, use is often made of holding chains with a through bolt. In order to achieve articulated, mechanical linkage in the case of this type of coupling, it is necessary to use a single bolt/shaft or possibly several bolts/shafts arranged along a common centre line. Each of the elements forming part of the coupling is of such a size so as to necessitate the use of a separate auxiliary crane in order to position the coupling elements correctly in relation to each other. Then striking tools or hydraulic tools must be used in order to guide the bolt/shaft into the through openings, between which openings and bolt there is often a relatively tight fit. The time taken to connect up heavy lifting gear constitutes a substantial part of the total lifting time for heavy packages, thereby contributing a considerable share of the lifting costs.

The object of the invention is to remedy the negative aspects of the prior art.

The object is achieved in accordance with the invention by the characteristics stated in the description given below and in the following claims.

A rapid coupling is fitted to the load attachment point of a crane or item of lifting equipment (hereinafter termed “crane”), which rapid coupling is designed to be able to couple the crane to a load to be lifted, essentially without the use of auxiliary tools. The rapid coupling comprises one or more hook-like lifting elements (hereinafter termed “hook”) and a yoke-like fastening device (hereinafter termed “yoke”) provided with axle journals that match the hooks. The yoke is designed to be fitted to the normal attachment fittings of the lifting tool while the hooks may be attached to the crane by conventional coupling elements.

On coupling a load to the crane, the hook(s) is/are inserted under the shaft(s) of the yoke and then lifted up so that the hook(s) abut(s) and partially enclose(s) the shaft(s). An actuator-operated lock, e.g. a hydraulically operated locking plate, is swung from a retracted, inactive position to an operative position in which the locking plate prevents the shaft from being pushed out of the hook. On uncoupling, the locking plate is swung into its inactive position, whereupon the hook(s) is/are lowered and pushed out of the shaft(s).

The following describes a non-limiting example of a preferred embodiment that is illustrated in the accompanying drawings, in which:

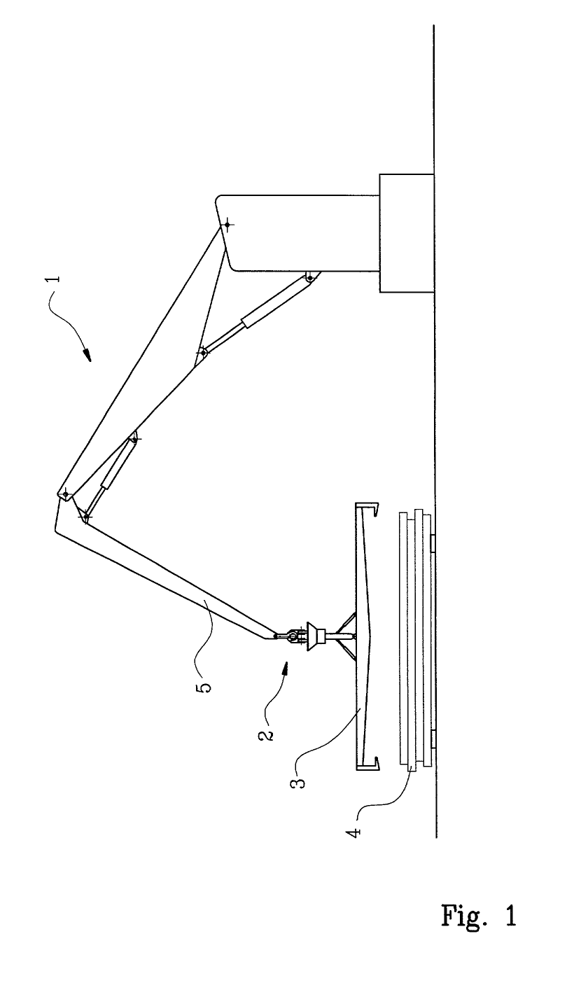

FIG. 1 shows a lifting tool connected to a crane via a rapid coupling;

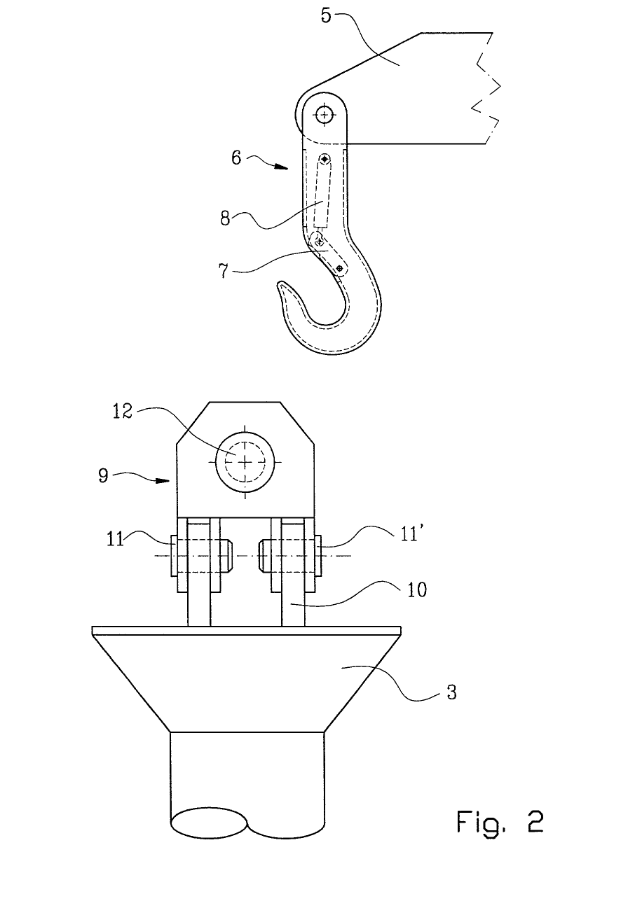

FIG. 2 is an enlarged side view of the rapid coupling in

FIG. 1 in an uncoupled position;

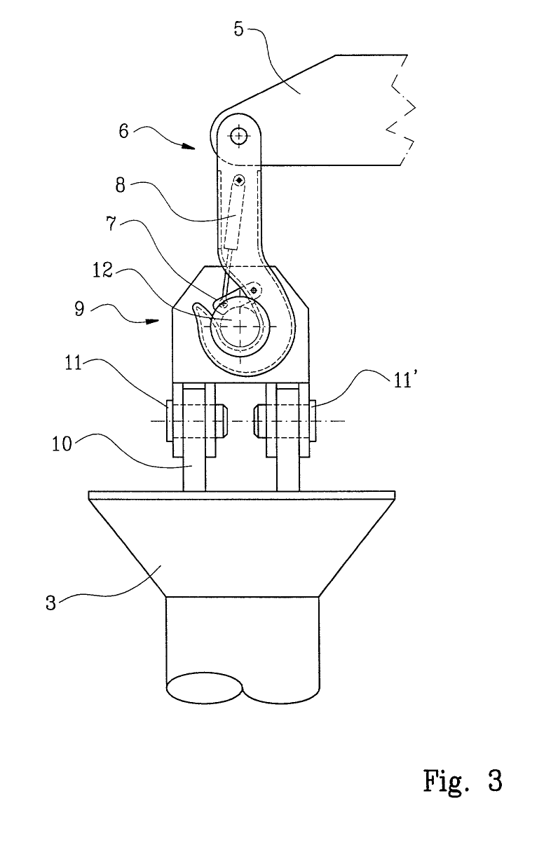

FIG. 3 is an enlarged side view of the rapid coupling in

FIG. 1 in a coupled position;

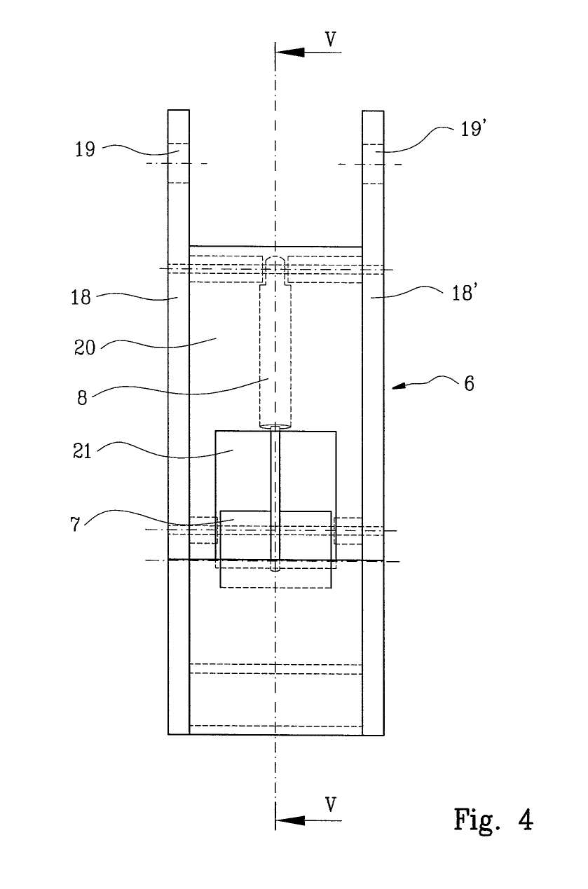

FIG. 4 is a front view of the hook of FIG. 3;

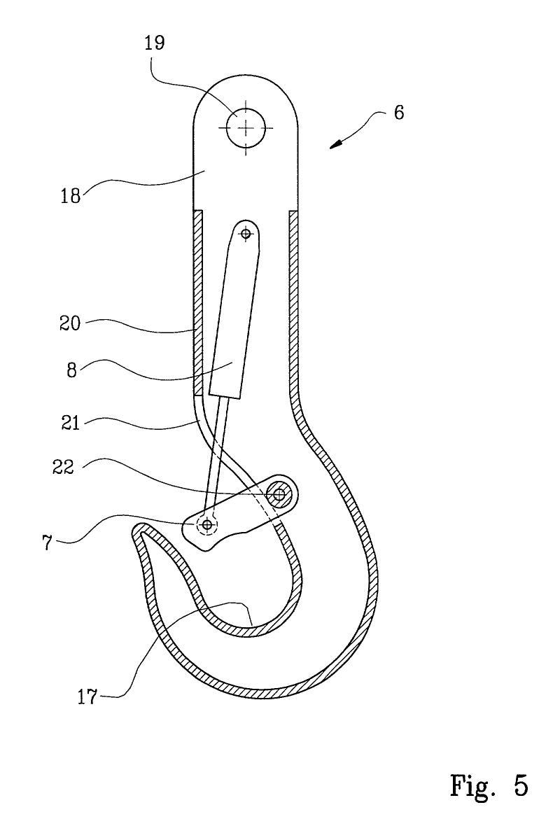

FIG. 5 shows a section through the hook of FIG. 4;

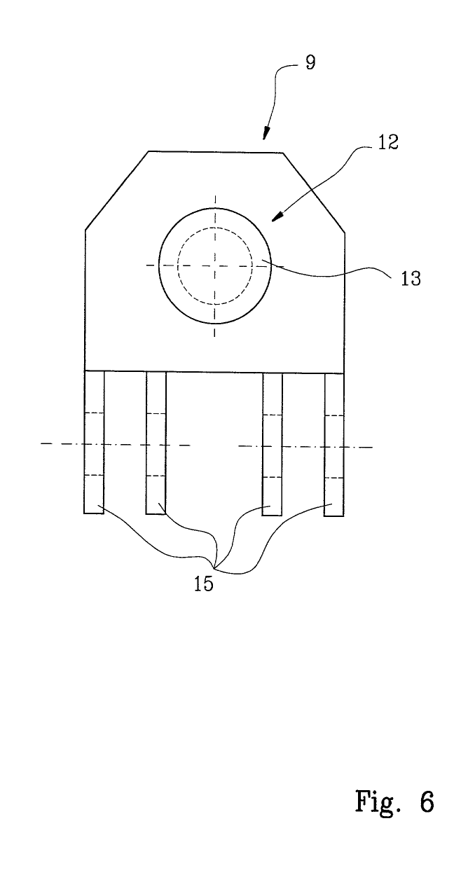

FIG. 6 is a side view of the yoke of FIG. 2;

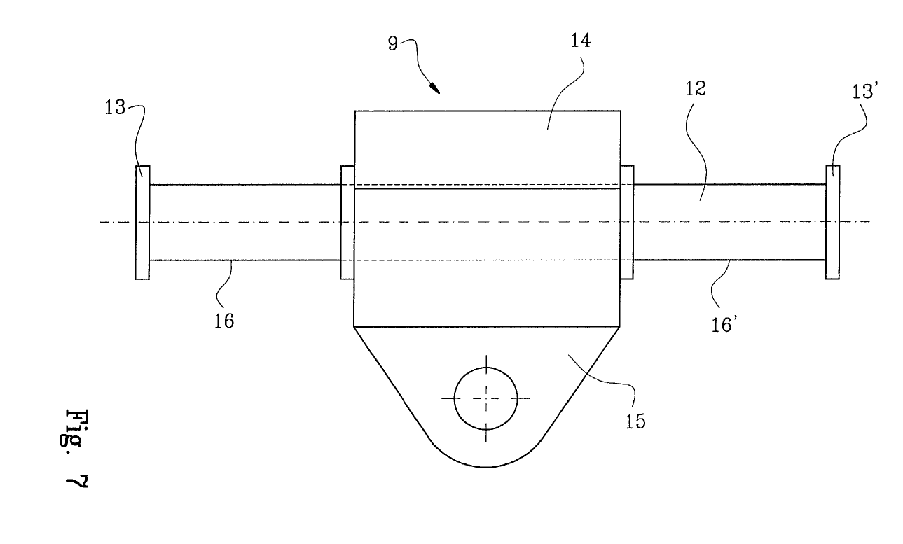

FIG. 7 is a front view of the yoke of FIG. 2; and

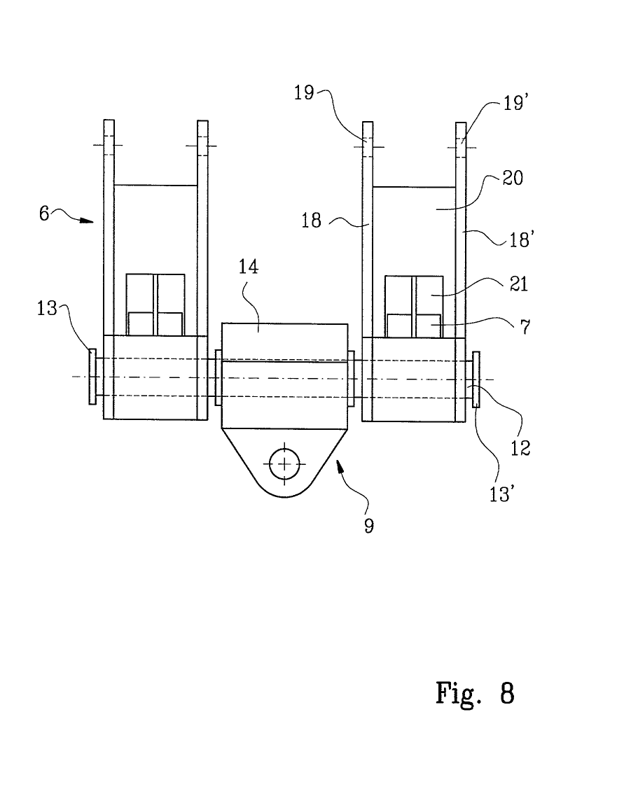

FIG. 8 is a front view of the rapid coupling.

In the drawings, reference number 1 denotes a multiarticulated crane coupled via a rapid coupling 2 according to the invention to a lifting tool 3 here shown in the form of a plate yoke for lifting of a load 4. In a preferred embodiment, the rapid coupling 2 is provided with two hooks 6 rotatably connected in the load attachment point 5 of the crane 1, see FIG. 2. In this figure, the locking plate 7 of the hook 6 has been swung in about a swivel axle 22 to its inactive position by an actuator 8, e.g. in the form of a hydraulic cylinder, by means of hydraulic tubes not shown. The other main part of the rapid coupling 2 is made up of a yoke 9 hinged to the ordinary attachment fittings 10 of the lifting tool 3 by two fastening bolts 11, 11′. The fastening bolts 11, 11′ are secured against falling out by means of cotter pins (not shown). In this preferred embodiment, the yoke 9 is equipped with a through shaft 12, see FIG. 7, both projecting end portions of which are provided with a flange 13, 13′. The mid section 14 of the yoke 9 is constructed as a welded plate construction and dimensioned so as to transfer the load from four hanging hinge lugs 15 to the shaft 12, see FIG. 6. The free portions of the shaft 12 between the mid section 14 and the flanges 13, 13′ form an abutment area 16, 16′ against the load bearing area 17 of the hook, see FIG. 5.

In the embodiment shown, see FIGS. 4 and 5, the hook 6 is constructed as a welded, hollow plate construction. Through openings 19, 19′ are provided at the upper end portions of the lateral plates 18, 18′ of the hook 6, which openings are adapted to the load attachment point 5 of the crane 1. The lower end portion of the lateral plates 18, 18′ is designed as a hook in order to be inserted radially across the load bearing area 16, 16′ of the shaft 12.

An intermediate plate 20 is shaped according to the contours of the lateral plates 18, 18′, forming a cavity in conjunction with the lateral plates 18, 18′. The intermediate plate 20 is provided with an opening 21 through which the locking plate 7 swings between its retracted, inactive position and its swung-out locking position. The locking plate 7 is rotatably attached to the lateral plates 18, 18′ of the hook 6 about the swivel axle 22. The actuator 8 is hinged to said lateral plates 18, 18′ and the locking plate 7 by means of linkages that are known per se.

On coupling up the hooks 6 of the rapid coupling 2 and the yoke 9, the hooks 6, in which the locking plate 7 is in the swung-in, inactive position, are guided in under the shaft 12 of the yoke 9. The hooks 6 are lifted such that the load bearing area 17 of the hooks 6 abuts the load bearing area 16, 16′ of the shaft 12. The locking plate 7 is rotated about its swing axle 22 to a swung-out locking position, see FIG. 3, which prevents the shaft 12 from being pushed out of the hooks 6. See FIGS. 3 and 8.

The coupling of a lifting tool 3 to the crane 1 is thus performed in a simple, safe and reasonable manner without the need for additional auxiliary lifting equipment, the crane 1 itself, by means of devices in accordance with the invention, being designed to be used for coupling and uncoupling lifting tools 3.

1. A device for coupling a load/lifting tool (3) to a crane (1) or other lifting equipment of the type used in heavy lift operations in which the load (4) must be controlled in such a manner that conventional hook, chain/wire tools can not be used, characterised in that the device for coupling up a load/lifting tool (3) is constituted by a rapid coupling (2).

2. A device in accordance with claim 1, characterised in that the rapid coupling (2) comprises one or more hook-like lifting elements (6) and a yoke (9) adapted for coupling to the hook-like lifting elements (6), where the yoke (9) and the hook-like lifting elements (6) are provided with attachment means (15, 19, 19′) designed to be coupled to the load attachment point (5) of the crane (1) and the attachment fittings (10) of the lifting tool (3) respectively.

3. A device in accordance with one or more of the preceding claims, characterised in that the hooklike lifting element (6) is equipped with an internally of the hook-like lifting element (6) provided locking plate (7) designed to be swung/displaced between an active locked position and an inactive position.

4. A device in accordance with one or more of the preceding claims, characterised in that the projecting shaft end portions (12) of the yoke (9) are provided with a radially projecting flange (13, 13′).
